(19) United States
(12) Patent Application Publication
(10) Pub. No.: US 2017/0231250 A1
(43) Pub. Date: Aug. 17, 2017

(54) CONFECTION COATING AND PROCESS FOR MAKING

(71) Applicant: WM. WRIGLEY JR. COMPANY, Chicago, IL (US)

(72) Inventors: Joo Song, Honolulu, HI (US); William Clark, Lombard, IL (US); April J. Tackett, Chicago, IL (US); Scott G. Brown, Oswego, IL (US)

(21) Appl. No.: 15/502,219

(22) PCT Filed: Aug. 5, 2015
(86) PCT No.: PCT/US2015/043722

§ 371 Date: Feb. 7, 2017

Related U.S. Application Data
(60) Provisional application No. 62/034,845, filed on Aug. 8, 2014.

(51) Int. Cl. A23G 3/54; A23G 4/04; A23G 4/20; A23G 3/42; A23G 3/34

(52) U.S. Cl. CPC A23G 3/54; A23G 3/42; A23G 3/0021; A23G 3/0023; A23G 4/20; A23G 4/043; A23V 2002/00

(57) ABSTRACT

An extruded confection comprised of one or multiple layers, wherein at least one layer provides a hard and brittle layer when chewed. Moreover, combinations of select saccharides are provided to achieve desired textural attributes when extruded as a lone layer or as one layer in a multiple layer confection. A process for creating the hard and brittle confection layer, which takes into account the rate of crystal growth of the saccharides is used to make the confection.

### FIELD OF THE INVENTION

The present invention relates to a process for making confection products that comprise a hard confection portion or a combination of portions wherein at least one portion is hard, and the confection products produced by that process.

### BACKGROUND OF THE INVENTION

Consumers have indulged in different forms of confection products for hundreds of years. Confection product production has changed over time to meet the interests, desires and needs of consumers, as well as the practical requirements of the confection product manufacturers. Confection products may be formed having various textures, such as soft, chewy, hard, brittle, etc., all of which are provided to meet the liking of the consumers. For example, some consumers like single textured hard confection products, and some like multiple textured confections wherein at least one portion is hard textured.

As the terms are used herein, confection products refer to the product that consumers purchase and consume. Ingredients in a confection product include saccharide mass and optionally additional ingredients such as, but not limited to colors, flavors, high intensity sweeteners, actives and sensates. The role of the saccharide mass in the confection product is to provide both sweetness and physical structure. A confection can have a single portion or be comprised of multiple portions. The portions in a multiple portion confection can comprise the same formula or different formulas. These portions can also sometimes be called “layers” as they are often assembled (i.e., collected or arranged) into a laminated arrangement of different layers adjacent to each other, like in a sandwich. A portion that exists on the outmost surface of a multiple portion confection product can be called a “coating”. A portion that exists in the center of a multiple portion confection product can be called a “center”. Coating and center terms can be used to describe the locations of the two portions of a pan coated confection or a filled rope confection.

As the term is used herein, saccharides include simple and complex sugars and simple and complex polyols. Polyols are hydrogenated versions of sugars and are used to make “sugar-free” confections. Simple saccharides include one to three single saccharide units. For example, fructose contains one saccharide unit. Sucrose contains two saccharide units: a fructose and a glucose. Complex saccharides include more than three saccharide units so complex saccharides have higher molecular weights and longer lengths than simple saccharides. Examples of three large complex saccharides used in confection products are corn syrup solids, polyglycitol, and polydextrose. Corn syrup solids contain long chains of dextrose. Polydextrose is a synthesized saccharide containing long chains of dextrose. Polyglycitol (also called hydrogenated starch hydrolysate) contains long chains of dextrose units with chain end sugars hydrogenated into alcohols. Saccharides include, but are not limited to, sucrose, fructose, dextrose, maltose, xylose, inulin, fructooligosaccharides, corn syrup solids, polydextrose, maltidextrins, starch, sorbitol, maltitol, isomalt, xylitol, erythritol, polyglycitol, hydrogenated maltidextrins, galactose, trehalose, tagatose, isomaltulose, and combinations thereof.

Upon consumption, a consumer perceives textures of the confection products as they are chewed. A hard confection product may be characterized as being crunchy when chewed. The consumer can feel and hear the sound of the confection product breaking-up into small pieces as it is chewed, that is, they can hear and feel a “crunch” during chewing. The smaller the broken pieces are, the more quickly the pieces dissolve in saliva resulting in a perceived fast delivery of ingredients in the confection mass, as well as a “crunch” sensation.

In general, consumers like variety in their confection products. Confection products with multiple textures due to multiple portions lead to multiple physical sensations perceived by the consumer. A confection product with multiple textures may further include multiple ingredient release characteristics, which result in varied delivery of sweetness, flavor, actives and senates. As used herein, senates are ingredients that create a physical response, including but not limited to, tingling, numbing, warming, cooling, and combinations thereof. As used herein, actives are ingredients that create a health or medical response in the body. A multiple portion confection can be a combination of hard and brittle confection portions and soft confection portions. Soft confections include chewing gums and chewy confections which do not contain gum base, such as but not limited to toffee, caramel, fudge, chocolate, nougat, licorice, fondant, gummy, jelly, grained candy, and combinations thereof can give a contrast in texture with the hard confection mass. The soft confection can also give a slower release of ingredients than a hard confection. Chewing gum and other soft confections are generally elastic and deform during chewing, but do not break or crack. Sweeteners and other water soluble ingredients (such as flavors and senates) are slowly released from the soft confections as saliva mixes with the soft confections during chewing and dissolves the ingredients.

Currently, the most common way of making a multiple textured confection with a hard and brittle confection portion and a soft confection portion is by a pan coating process. In general, the pan coating process involves multiple spray applications of supersaturated solution containing saccharides on to confection centers that are tumbling in a coating pan (i.e., Driam, or other tumbling apparatus) with pauses between spray applications to allow evaporation of moisture that is present in the applied spray solution. During the pauses between spray applications, crystals grow on the outer surface of the confection centers. Applications of solution continue to be applied to the outer surface of the centers until the preferred amount of saccharides have accumulated.

There are several challenges with the pan coating processing. One challenge is the required processing time necessary to create the hard texture coating is the numerous spray applications and pauses in between the spray to build the coating. For crystal formation to occur on the center, time must be allowed to evaporate the water in each spray application and to grow the crystals. Another challenge of the pan coating process is that care must be taken with each application so that a spray application does not dissolve the crystals formed from an earlier application.

The pan coating process may also be done using molten saccharides as the mass sprayed onto the centers. The use of molten saccharides in spray applications requires time between each spray application for cooling and crystallizing the saccharide son the centers. Care must be taken that later applications do not re-melt earlier applications. A challenge when using a molten saccharide mass as the spray applied to the pieces is choosing the saccharides for the spray application that; a) have a very low viscosity when heated; b) will turn into glass form (i.e., amorphous) as the spray droplets cool; and c) then turn into crystals when the glass droplets adhere to the surface of the centers. The applied saccharide mass cannot be very hygroscopic or the brittleness of the resulting coating will be reduced as the sprayed materials absorb ambient water. The saccharides chosen for the saccharide spray must also have a very low melt temperature and a slow rate of crystallization so that no crystals will form in the spray equipment.

The pan coating process, whether using super saturated saccharide solution of molten saccharides, also includes limits on the final form, of the multiple portion confection product. The pan coating process includes tumbling the centers in a rotating pan or cylinder while being sprayed. The tumbling process rounds edges and corners of the centers as the coating saccharide mass are applied around roughly the entire outer surface of the centers. The tumbling is a necessary part of the pan coating process as it creates the friction, which aides in creating crystal growth in the applied saccharide mass.

A different process for making a multiple portion confection product is through the use of an extrusion process. By extrusion, it is meant the confection manufacturing process by which a confection mass (that contains a saccharide mass and optionally additional ingredients)) is mixed and heated in an enclosed container (e.g., extruder), and then forced (or pushed) out of the container through an exit opening in the enclosed container (e.g., die plate opening). With extrusion, force is applied to confection product held within the enclosed container by means such as a screw in the enclosed container. The form of the exiting confection product (e.g., rope, ribbon, and sheet) is dependent on the dimensions of the die plate opening, the viscosity and film character of the confection product, and the differential between the pressure within the closed container and the pressure outside the closed container. The die plate with at least one opening creates an extruded form in the shape of the die plate opening.

The challenge of the extrusion process when at least one hard confection portion is to be made as a final confection product, or as a part of a final multiple portion confection product, is the physical character of the confection product while and after it is extruded. The extruded confection product must be such that it will have a viscosity and film character that will allow for mixing in an enclosed container (e.g., extruder), exiting the enclosed container in a form (e.g., rope, ribbon, or sheet) dictated by the opening in the enclosed container (e.g., die plate opening), and maintaining that form while being flexible enough to be further processed (such as forming and finishing) and then becoming hard and brittle after processing. With the extrusion process, extruded confection portions can be assembled together as they are formed or assembled together in a separate process step.

A challenge in using the extrusion process for making a single hard and brittle confection portion to be consumed alone, or to use the process to make a multiple portion confection product with at least one hard and brittle confection portion, is that the viscosity and cohesiveness of the confection product, which is created by its film character, influences the ability of the extruded confection mass to hold its form (i.e., rope, ribbon, or sheet) through further processing steps, such as shaping and finishing. If the confection product (containing the saccharide mass) has a low viscosity and/or no film character, the extruded confection product may be forced to exit the extruder, but the extruded product will be a formless flow of fluid mass, like pancake syrup. The cohesiveness of the confection product comes from its film character, which in theory comes from the interactions of the complex saccharides within the saccharide mass of the confection product. Film character comes from long molecules entangling with other long molecules to create a film. In this case, complex saccharides, such as polyglycitol, polydextrose, and corn syrup solids, contain long molecules that will entangle with themselves and with other saccharides in the saccharide mass to create a film character that results in a cohesive extruded formed mass. The greater the long complex saccharide content of the saccharide mass, the greater the strength of the formed extruded mass exiting the enclosed container.

An extrusion apparatus, such as a twin screw extruder, used to make a hard and brittle confection portion, alone or in combination with another portion, has the ability to mix a confection product (containing a saccharide mass), heat the mixed confection product until all saccharide crystals are melted, and then force the confection product through an opening in the extruder, such as a die plate opening. Extrusion requires that the confection product being forced through the die plate opening, have a flexible texture at the temperature of extrusion with a viscosity and film character sufficient to flow through the die plate opening and then to hold its form (e.g., rope, ribbon, sheet) after exiting the die plate opening.

To make a confection product with multiple portions using an extrusion process, the confection portions can be made at the same time, or made separately and then assembled. When multiple portions are produced at the same time, that is, co-extruded, then the two confection masses are separately mixed, heated, and forced through a die plate with an opening for each portion. With co-extrusion the portions are assembled together as they are forced through the same die plate. The portions can be in any arrangement, such as but not limited to laminated arrangement (e.g., parallel layers) and concentric arrangement (e.g., filled rope). When the extruded confection portions are adjacent to each other as they flow through the die plate opening or after the die plate opening, the temperatures of each mass can affect the temperature of the other portion. Such affects include, but are not limited to changes in viscosities or crystal growth rate. When multiple portions are made separately and then assembled after leaving the extruder, the two confection portions are separately mixed, melted, and formed into ropes, ribbons, or sheets as each passes through their separate die plate openings. The separate portions are then assembled in a number of arrangements, such as but not limited to a laminated layer arrangement (e.g., sandwich appearance).

The challenge is choosing the contents of the saccharide mass of the confection product so that the saccharide mass can create the necessary viscosities and film character necessary for extruding through the die plate opening, and then holding the saccharide mass's post die form (i.e., rope, ribbon, or sheet) at temperatures that will not damage any other portions it might be assembled with. A major consideration is that the melting points of many saccharides are quite high (many are over 150° C.), while the melting point of many soft confection products, such as chewing gum is 50-60° C. A combination of layers at such temperatures could cause melting and possible damage of the soft confection portion.

A confection product contains many different ingredients, each with their own purpose. A confection product that could have a hard and brittle texture under appropriate processing conditions would need to contain a saccharide mass that could provide that texture under those processing conditions. Other ingredients could be included in the confection product if these ingredients would not interfere chemically or physically with the saccharides in the confection product. Such ingredients include, but are not limited to, flavors, colors, high intensity sweeteners, sensates, actives, and combinations thereof.

To be able to choose or alter the physical properties of a saccharide mass, in order to create the desired finished confection product's hard and brittle texture, would be particularly useful in the creation of multiple portion confections with at least one hard and brittle portion. It would be useful to have a way of choosing the contents of a saccharide mass that would be flexible and fluid during processing, but become hard and brittle before it is consumed. It would be useful to be able to choose a saccharide mass, such that the temperature required to extrude that saccharide mass would not be so high that it would damage any other confection portions assembled with it. It would be useful to have the flexibility to design a confection product, and the process for making that product, that would create an extruded confection mass with a predictable amount of hardness and crystal content in the finished product.

### SUMMARY OF THE INVENTION

An extruded confection product comprised of one or multiple portions, wherein at least one portion provides a hard and brittle portion when chewed. Moreover, combinations of selects saccharides are provided to achieve desired textural attributes when extruded as a single portion or as one portion in a multiple portion confection product. A process for creating the hard and brittle confection portion, which takes into account the rate of crystal growth of the saccharides used to make the confection product.

### DETAILED DESCRIPTION OF THE INVENTION

The present invention relates to confectionary compositions comprising a saccharide mass, which has a viscosity appropriate for extruding a confection portion that will remain flexible in texture through processing, and then harden and become brittle before consumption. The hard and brittle portion could be consumed alone or assembled with other confection portions in a multiple portion confection.

The present invention relates to a way to choose the contents of a saccharide mass such that the molecular weight, Tₘ and T_{g} of the saccharides will create a saccharide mass, which will have a net viscosity and film character appropriate for creating an extruded confection mass that remains flexible through various process steps and yet hardens and becomes brittle before the confection product is consumed. This means that the molten saccharide mass (containing the chosen saccharides) would be viscous enough to be extruded, and yet flexible enough to be shaped and finished, while retaining its ability to harden and crystallize further down the production process. For a multiple portion confection, this invention also relates to the molten saccharide mass that will become the hard portion will be extruded through the die plate opening at a temperature that will not damage any other portion in the multiple portion confection.

This invention also relates to the choosing of saccharides for the saccharide mass such that the rate of crystal growth of the saccharide mass has been slowed by choice of saccharides based on T_{g} and Tₘ and the processing temperatures. Such crystal rate allows for extruding, shaping, and finishing the saccharide mass before crystal growth creates a hard saccharide mass texture.

In general, saccharides are simple and complex sugars and polyols. Simple saccharides include one to three saccharide units and complex saccharides include four or more saccharide units. Saccharides vary greatly in their physical characteristics. Table 1 includes a non-limiting list of saccharides and their physical characteristics.

TABLE 1
Saccharides: Molecular Weight, Tm, Tg, Degree of Hygroscopicity

| | Molecular | | | |
|---|---|---|---|---|
| | Weight | | | Degree of |
| Saccharide | (daltons) | Tₘ (° C.) | T_{g} (° C.) | Hygroscopicity |
| Fructose | 180 | 105 | −42 | High |
| Dextrose | 180 | 146 | −43 | Low |
| Sucrose | 342 | 179-186 | −32 | Low |
| Starch | 200-4,000 | NA | 243 | Low |
| (approximate) | | | | |
| Corn Syrup | 200-4,000 | NA | 80 | Medium |
| Solids | | | | |
| (approximate) | | | | |
| Polydextrose | 250->22,000 | amorphous | 100-120 | High |
| (approximate) | | | | |
| Erythritol | 122 | 121 | −42 | Very Low |
| Xylitol | 152 | 92-96 | −29 | High |
| Sorbitol | 182 | 99-101 | −9 | Medium |
| Mannitol | 182 | 165-169 | 13 | Very Low |
| Isomalt | 344 | 145-150 | 64 | Very low |
| Maltitol | 344 | 144-147 | 39 | Low |
| Polyglycitol | 1,000-3,600 | 173-179 | UK | Low |
| (approximate) | | | | |
| Carnauba Wax | unknown | 82-86 | NA | NA |

UK = unknown

The physical properties of saccharides are dependent on their molecular weight (mw), crystal melt temperature (Tₘ), glass transition temperature (T_{g}), and degree of hygroscopicity. The molecular weight (mw) is the physical weight of the molecules in daltons. Simple saccharides contain one to three sugar or hydrogenated sugar (i.e., polyol) units and have low molecular weights. Because of their molecular composition, simple saccharides can create tightly bonded crystal structures, which are related to their crystal melting temperature (Tₘ).

Complex saccharides have more than three, and usually hundreds, of single saccharide units. These complex saccharides are less likely to crystallize, or may crystallize in only limited portions of their structures, at least partly due to physical difficulties in aligning their parts into organized crystal forms. The larger the molecular weight, the slower the saccharide molecules move when heated, creating a high viscosity. The larger molecular weight saccharides are long and often branched. Both of these characteristics reduce the molecule's tendency to crystallize. Polydextrose is a synthetic polymer of dextrose units. It is difficult for the body to digest polydextrose, so it can be used in sugar and sugar-free products. Corn syrup solids are produced by acid and/or enzymatic degradation of corn starch. The resulting dried mass contains some simple sugars, but mostly long polymers of simple sugar units. Polyglycitol (also called hydrogenated starch hydrolysate) is produced by hydrogenating mixtures of sugars, maltidextrins, starch, and/or corn syrup. Polyglycitol contains some simple polyols, though it is mostly long polymers of simple polyols. In many confection products, polyglycitol is a replacement for corn syrup in the same way as maltitol is a replacement for maltose.

The crystal melting temperature (Tₘ) is the temperature at which saccharide crystals will melt. Molten saccharides will recrystallize at roughly the same temperature as the temperature they melted at. Crystal re-growth can be influenced by the concentration of like molecules and concentration of interfering molecules. The glass transition temperature (T_{g}) is the temperature at which melted saccharides will transition from fluid to solid as the saccharide mass is cooled, or will transition from solid to fluid as the saccharide mass is heated. The fluid character can be measure in terms of its viscosity. With saccharides that do not crystallize (that is, they are amorphous), they can exist in a fluid form that changes in viscosity at the saccharide's T_{g} value. Viscosity is the measure of the fluidity of the saccharide mass. There are several ways to measure viscosity. Viscosity is the resistance of a material to flow. Viscosity=shear stress/shear rate. The shear rate is the velocity gradient in a flowable material and it relates to the shape of the spindle (for example, “T” shape) moved through a sample and the rotational speed of the spindle (for example, at a set speed of 2-8 seconds⁻¹) turning in a certain amount of sample material at a set temperature (for example, 110° C. or 150° C.). Poise is the unit of measurement of velocity. The greater the resistance of the mass to flow, the larger the Poise number, and so the greater the viscosity reading. Viscosity can be another means of characterizing a saccharide mass. For example, a molten saccharide mass, which would be have a viscosity reading of about 24 to about 815 Poise at a shearing rate of 2-8 seconds⁻¹, would flow through a die plate opening to form a rope, ribbon, or sheet while at a 110° C.-150° C. A greater viscosity could possibly clog the die plate opening, while a lower viscosity could possibly flow through the die plate opening like pancake syrup.

The degree of hygroscopicity of a saccharide is the tendency of a saccharide to absorb ambient moisture. This characteristic of saccharides is a greater concern when there is water added to a saccharide mass, as the greater the degree of hygroscopicity, the harder it will be to remove the water as the saccharide will cling to the water. As degree of hygroscopicity relates to the current discussion, the greater the hygroscopicity of a saccharide, the greater the tendency for the saccharide to absorb ambient moisture, resulting in a greater tendency of the saccharide mass to become sticky. Generally, the larger and the more branched the saccharide molecule is, the greater the molecule's hygroscopicity. The moisture absorbed by a saccharide with a high degree of hygroscopicity can dissolve some of the simple saccharides on the surface of the saccharide mass and make the surface sticky.

These properties aid in guiding the choosing of saccharides for a saccharide mass to meet a process need, such as a viscosity necessary to mix and extrude a saccharide mass at a temperature that will not damage any confection portions assembled with it. The properties also aid in guiding the choosing of saccharides for a saccharide mass that has a rate of crystallization slow enough to maintain the flexibility needed to extrude, form, shape, and finish a confection product, and yet are hard and brittle before consumption.

An example of combining saccharides in order to create a flexible saccharide mass during processing, and a hard and brittle mass during consumption is the combination of maltitol, erythritol, and polyglycitol. Maltitol is a commonly used saccharide in sugar-free confection products. By itself, dry crystalline maltitol is difficult to mix as it is melted due to its high viscosity. When this mixing and melting is done in an enclosed container with a screw for mixing (e.g., extruder), the energy needed to be applied during the mixing is very high and impractical for traditional candy manufacturing equipment. A means of reducing that energy requirement includes adding to the saccharide mass containing maltitol a small percent of erythritol.

Each saccharide's Tₘ and T_{g} can be used to help explain this partnership between maltitol and erythritol. Crystalline maltitol has a Tₘ of 144° C. and at T_{g} of 39° C. (Table 1). Maltitol's melt viscosity is very high and it requires a very high amount of energy to mix the mass when it is being melted. Also, the presence of unmelted maltitol crystals physically impedes at least some of the flow of the melted maltitol. The addition of a few percent of a simple saccharide, such as erythritol, will reduce the energy needed to mix the maltitol because the simple saccharide has a Tₘ of 121° C. (less than that of maltitol) and a T_{g} of −42° C. (less than that of maltitol). The erythritol acts as a lubricant to allow the flow of the maltitol through the enclosed container and out through a die plate opening at one end of the enclosed container. The saccharide mass will exit the die plate opening with enough structural body to maintain some shape structure, but not for very long.

The addition of erythritol to the maltitol saccharide mass reduces the rate of crystallization of the saccharide mass as the mass cools post exiting through the die plate opening into ambient temperature. Though the melted amorphous maltitol will decrease in viscosity and start to crystallize as the temperature of the saccharide mass cools, the melted erythritol (with its lower viscosity than that of maltitol) will continue to contribute lubricity and fluidity in and around the higher viscosity maltitol. If the amount of erythritol present in the mixture is high enough, it could also form enough crystals as the saccharide mass cools to reduce the fluid nature of the melted maltitol by erythritol crystals physically breaking up the continuity of the melted maltitol. As the mixed saccharide mass cools, the rate of maltitol crystal growth will increase as the mass cools towards its Tₘ. To maintain the flexible texture needed to form, shape and finish the extruded saccharide mass into individual pieces, the cooling temperature would be controlled so that the maltitol crystal growth is limited until after shaping and finishing process steps are completed.

One challenge of this combination of two simple polyols (e.g., maltitol and erythritol) is in creating an extruded saccharide mass that will maintain its form (e.g., rope, ribbon, sheet) after the saccharide mass leaves the die plate opening. There is only a very limited amount of bonding between two different simple saccharides, such as maltitol and erythritol. The addition of a large complex saccharide, such as polyglycitol, creates some cohesion throughout the extruded saccharide mass that allows the extrusion of a stable form (e.g., rope, ribbon, and sheet). Polyglycitol has film forming properties, which created the cohesion in the three component saccharide mass. Polyglycitol is a large complex saccharide. Other large complex saccharides include, but are not limited to, polydextrose and corn syrup solids. Polydextrose is the most hygroscopic of these three saccharides.

When the above described maltitol and erythritol saccharide mass also contained a small amount of polyglycitol, the polyglycitol created a cohesive framework, or film, with the erythritol and maltitol molecules. This film creation allows the cooling saccharide mass to be more flexible over a longer temperature and time frame. If the end goal is to have a hard and brittle confection portion when the confection product containing the saccharide mass was finally at room temperature, then the amount of added complex saccharide needs to be low, as the complex saccharide molecules can reduce the amount of simple saccharides that will crystallize due to physical impediment. Also, the complex saccharides can be hygroscopic and absorb ambient moisture that could dissolve simple saccharides on the surface of the mass, creating a sticky product surface. Finally, even if the simple saccharides do crystalize, the complex saccharides for the most part do not crystallize, creating flexible or chewy texture and not the preferred hard and brittle texture.

If a saccharide mass is mostly composed of complex saccharides (such as polyglycitol, polydextrose, or corn syrup solids), then the addition of a simple saccharide to the saccharide mass will create a viscosity during mixing and melting that would require less energy for heating and mixing then a saccharide mass comprising only complex saccharides. In general, the larger the saccharide, the greater its viscosity at a set temperature. These large complex saccharides (e.g., polyglycitol, polydextrose, corn syrup solids) can be heated to a point where the energy needed during mixing and heating would be reasonable and the viscosity would be such that it could be forced through a die plate opening. But, the flexible nature of the resulting extruded saccharide mass would be too great, creating an extruded saccharide mass that would be too low in viscosity to hold a form. The complex saccharide extruded mass would also be at a temperature likely to damage many confection portions, such as chewing gum, that would be assembled with it after extrusion.

A saccharide mass containing a lot of large complex saccharides can have its viscosity reduced by adding to it a small percentage of simple saccharides, especially if the Tₘ of the simple saccharide is less than the Tₘ of the large complex saccharides, because the simple saccharide will melt first and add lubricity and fluidity to the saccharide mass before the complex saccharides are melted. If the T_{g} of the simple saccharide is less than that of the complex saccharide, then the viscosity of the melted simple saccharide will add to the fluidity of the saccharide mass. Non-saccharide lubricants, such as, but not limited to wax or fat, can be added to a saccharide mass containing large complex saccharides to add lubricity that would be needed as the mass is mixed, melted, and forced through a die plate opening. The non-saccharide lubricants melt as the saccharide mass is mixed and melted. The fluid non-saccharide lubricant adds to the fluidity of the saccharide mass as it moves through and out of the enclosed container. If the non-saccharide lubricant (such as wax or fat) is hydrophobic, because saccharides are hydrophilic, the non-saccharide lubricant will flow to the outside of the mixing confection product. When the confection product (containing the saccharide mass) exits through the die plate opening, the non-saccharide lubricant is on the outer surface of the product and aids in the confection product getting through the opening, adds a shine to the confection product, and gives the confection product some protection against absorption of ambient moisture. It has been found that the preferred choice of saccharides would be a combination of saccharides that would: a) create a viscosity during mixing and melting in an enclosed container with a mixing screw (e.g., extruder) that would require an acceptable energy level during mixing; and b) create an extruded saccharide mass that would exit the apparatus through a die plate opening as a rope, ribbon, or sheet with a preferred viscosity of about 24 to about 815 Poise measured at a shearing rate of 2-8seconds⁻¹ at a preferred temperature range of about 110° C. to about 150° C. (as measured using a Brookfield apparatus). If the extruded saccharide mass is at the preferred temperature range as it exits the die plate opening, or is extruded and then tempered at a later time to the preferred temperature range, the temperature of this rope, ribbon or sheet will not damage a soft confection layer that is assembled with it to make a multiple portion confection. If the simple saccharides crystallize, but the saccharide mass does not harden, but instead stays soft and flexible, then the formula of the saccharide mass and the processing conditions used to mix and melt it created a “grained” confection instead of the intended hard and brittle confection. The “grained” description comes from the presence of saccharide crystals noticeable in a flexible confection product.

The process for creating a confection product that contains a saccharide mass that will form the preferred hard, brittle, and crunchy texture as a stand-alone confection portion or as a portion in a multiple portion confection product, comprises the processing steps of 1) choosing an appropriate confection product with a mixture of saccharides and any additional ingredients that will not interfere with the saccharide mass (such as, but not limited to flavor, color, high intensity sweeteners, sensate, active ingredients, and combinations thereof); 2) putting the dry confection product into an apparatus (i.e., enclosed container) with mixing and heating capabilities (such as, but not limited to an extruder with twin screws); 3) mixing and heating the confection product to a temperature greater than the melting point of the saccharide with the largest Tₘ so that all of the saccharide crystals are melted; 4) forcing the confection product through an opening in the mixing and heating enclosed container (such as, but not limited to a die plate opening in a extruder); and 5) forming the confection product into a rope, ribbon, or sheet as it exits through the die plate opening.

The extruded confection product can be further processed into a product ready for consumption, the process steps including: 1) shaping the formed confection product into individual pieces (such as by cutting with a wire, roller, wheel, knife, drop roller, rotary cutter, Uniplast, or combinations thereof); and 2) finishing the individual pieces (such as, but not limited to, pressing, embossing, dusting with dry particulates, spray with liquid ingredients, pan coating, or combinations thereof).

If the confection product is to be a portion in a multiple portion confection product, then further processing steps include: 1) assembling the formed confection product with additional confection portions (such as, but not limited to, chewing gum, or chewy confection); 2) shaping the multiple portion confection mass into individual pieces (such as by cutting with a wire, roller, wheel, knife, drop roller, rotary cutter, Uniplast, or combination thereof); and 3) finishing the individual pieces (such as, but not limited to, pressing, embossing, dusting with dry particulates, spraying with liquid ingredients, pan coating, or combinations thereof). Preferably the molten confection product is created with a saccharide mass such that the saccharide mass (and so the confection product) has a viscosity of about 24 to about 815 Poise measured at a shearing rate of 2-8 seconds⁻¹ at a preferred temperature range of about 110° C. to about 150° C. (as measured on a Brookfield viscometer).

Preferably, the enclosed container apparatus (e.g., extruder) is designed so as to have continuous forward flow and adjustable application of shear and heat throughout the mixing and melting process areas of the apparatus. Preferably the apparatus could provide adjustable mixing (i.e., adjustable shear) throughout the apparatus through the integration of a screw configuration (containing at least one screw, preferably twin screws) running longitudinally through the apparatus from the entrance port, through the mixing and melting sections and to the opening (e.g., die plate opening). One means of creating adjustable shear is through the use of adjustable screw elements. In one preferred embodiment, a twin screw, intermeshing, co-rotating screw arrangement runs longitudinally through the extruder from entrance port and through the mixing and melting sections, to the die plate opening.

The die plate opening could be replaced with any apparatus piece that would aid in restricting the flow of the confection product as it moves from the mass in bulk in the enclosed container to formed rope, ribbon, or sheet outside the enclosed container. A nozzle is an example of an apparatus piece that would meet these requirements. As the flow is restricted as it flows through the nozzle (or die plate opening) the confection product creates a rope, ribbon or sheet form with the cross section geometry dictated by the nozzle (or die plate opening) the mass flows through.

The shaping process step can include the cutting of the extruded confection product into individual pieces. This could be done with various pieces of equipment, including but not limited to, cutting with a wire, roller, wheel, knife, drop roller, rotary cutter, Uniplast, or combination thereof. The shaped individual pieces could have open ends such that any interior portions would be visible, or the individual pieces could be pinched so that any interior portions would not be visible.

The finishing process step may further include rollers or wheels that may press any assembled portions together and/or press a pattern into any single or assembled portions (i.e., embossing), or otherwise mark the confection product surface. The finishing process step may also include dusting the confection product surface with dry particulates. The particulates could include, but are not limited to colored or uncolored particulates comprising waxes, fat, oil, sweeteners, high intensity sweeteners, colors, flavors, senates and combinations thereof. Further, the particulates may include flavor beads, nut pieces, or fruit pieces. The finishing process step may also include spraying the surface of the confection mass with a liquid. The material sprayed may include, but is not limited to, colored or uncolored liquids comprising saccharide syrups, molten saccharides, molten waxes, molten fat, molten chocolate, molten compound coatings, oil, high intensity sweeteners, colors, flavors, sensates, actives, and combinations thereof.

In this confection manufacturing process, the confection product is heated until all of the saccharide crystals in the confection product are melted, and then the confection product is tempered in such a way so as to reduce the crystal growth rate until all of the confection product is formed, shaped, and finished. The confection mass can be purposely cooled after the confection has completed the finishing process step in order to speed up crystal growth before individual confection pieces are packaged.

In an embodiment of the present invention, a single confection portion that is hard and brittle when chewed, is produced by an extrusion process wherein a dry mixture of confection ingredients (including a saccharide mass and additional ingredients including but not limited to colors, flavors, high intensity sweeteners, sensates, actives, and combinations thereof) are added to an extruder with twin screws running longitudinally through the extruder; the confection mass is then mixed and heated in the extruder until all saccharides crystals are melted, then the confection mass is forced out of the extruder through a die plate opening (or nozzle) at the end of the extruder opposite where the dry confection mass entered the extruder; and finally the heated and extruded mass is shaped into individual pieces and finished. In a further embodiment of the present invention, the extruded mass has a viscosity of about 24 to about 815 Poise measured at a shearing rate of 2-8 seconds⁻¹ at a preferred temperature range of about 110° C. to about 150° C. (as measured on a Brookfield viscometer).

In an embodiment of this invention, a confection product contains a saccharide mass comprising 70-98 wt. % simple saccharide; and 30-1 wt. % of a different simple saccharide; wherein the confection product has a viscosity of about 24 to about 815 Poise measured at a shearing rate of 2-8 seconds⁻¹ at a preferred temperature range of about 110° C. to about 150° C. (as measured on a Brookfield viscometer).

In an embodiment of this invention, a confection product contains a saccharide mass comprising 70-98 wt. % simple saccharide, 1-30 wt. % of a different simple saccharide, and 0.30-10 wt. % complex saccharide, wherein the confection product has a viscosity of about 24 to about 815 Poise measured at a shearing rate of 2-8 seconds⁻¹ at a preferred temperature range of about 110° C. to about 150° C. (as measured on a Brookfield viscometer).

In an embodiment of this invention, a confection product contains a saccharide mass comprising 70-98 wt. % simple saccharide, 30-1 wt. % of a different simple saccharide, 0.30-10 wt. % complex saccharide, and 1-4 wt. % fat or wax, wherein the confection product has a viscosity of about 24 to about 815 Poise measured at a shearing rate of 2-8 seconds⁻¹ at a preferred temperature range of about 110° C. to about 150° C. (as measured on a Brookfield viscometer).

In another embodiment of this invention, a multiple portion confection product contains a first confection portion and a second confection portion, wherein the two confection portions are assembled together, and one confection portion has a hard and brittle texture at room temperature and the other has a soft and chewy texture at room temperature.

In an embodiment of this invention, a confection product contains a saccharide mass comprising 40-60 wt. % simple saccharide and 60-40 wt. % complex saccharide, wherein the confection product has a viscosity of about 24 to about 815 Poise measured at a shearing rate of 2-8 seconds⁻¹ at a preferred temperature range of about 110° C. to about 150° C. (as measured on a Brookfield viscometer).

In an embodiment of this invention, a confection product contains a saccharide mass comprising 40-60 wt. % simple saccharide, 60-40 wt. % complex saccharide, and 1-10 wt. % of a different simple saccharide, wherein the confection has a viscosity of about 24 to about 815 Poise measured at a shearing rate of 2-8 seconds⁻¹ at a preferred temperature range of about 110° C. to about 150° C. (as measured on a Brookfield viscometer).

In an embodiment of this invention, a confection product contains a saccharide mass comprising 40-60 wt. % simple saccharide, 60-40 wt. % complex saccharide, 1-10 wt. % of a different simple saccharide, and 1-4 wt. % fat or wax, wherein the confection product has a viscosity of about 24 to about 815 Poise measured at a shearing rate of 2-8 seconds⁻¹ at a preferred temperature range of about 110° C. to about 150° C. (as measured on a Brookfield viscometer).

In another embodiment of this invention, a multiple portion confection contains a first confection portion comprising a first saccharide mass, and a second confection portion, wherein the two confection portions are assembled with each other, and the texture of the first confection portion is hard and brittle at room temperature.

### EXAMPLES

Confection product samples were made with at least one confection product comprising a saccharide mass. The saccharide mass contained a mixture of different saccharides After being heated and mixed until all saccharide crystals were melted, the confection product was then cooled to about 110° C. to about 150° C., where the viscosity was about 24 to about 815 Poise measured at a shearing rate of 2-8 seconds⁻¹ (as measured on a Brookfield viscometer). The confection products that met this viscosity and temperature requirement contained two different saccharides or three saccharides. Sometimes other ingredients were present in the confection product with the saccharides, such as color or flavor that did not physically or chemically change the physical properties of the saccharides in the confection product. Sometimes wax was added to the confection product to lubricate that ingredients or to add fluidity to the ingredients, but without physically or chemically changing the physical properties of the saccharides in the saccharide mass. These confection product formula samples were evaluated as to their contents, which are recorded in Table 2 and Table 3. Viscosity readings were not taken on all of the formulas recorded in Table 2 and Table 3, but the visual viscosity and ability to create a hard and brittle confection product with these formulas appeared to be similar to that of the formula that was viscosity tested.

TABLE 2
Saccharide Mass Formula Content

| | Formula | Formula | Formula | Formula |
|---|---|---|---|---|
| | 1 | 2 | 3 | 4 |
| | (wt. %) | (wt. %) | (wt. %) | (wt. %) |
| Maltitol | 80-99 | | | |
| Polyglycitol | 3-10 | 20-80 | | 0-50 |
| Polydextrose | | | 45-70 | |
| Isomalt | | 0-50 | | 20-96 |
| Xylitol | | 0-30 | | 0-30 |
| Maltitol | | 0-50 | | |
| Erythritol | 1-4 | 0-30 | | 0-10 |
| Sorbitol | | 0-30 | | |
| Dextrose | | 0-30 | 20-30 | |
| Fructose | | | 20-30 | |
| Modified Starch | 0-2 | 0-4 | 0-6 | 0-2 |
| Carnauba Wax | 0-3 | 0-3 | 0-3 | 0-3 |

Table 2 includes several saccharides explored in making a confection product (that contained a saccharide mass) that had a viscosity of about 24 to about 815 Poise measured at a shearing rate of 2-8 seconds⁻¹ at a preferred temperature range of about 110° C. to about 150° C. (as measured on a Brookfield viscometer).

Saccharide mass formulas included a simple saccharide, that was combined with a different simple saccharide, and possibly with a complex saccharide, in order to create a molten saccharide mass that had the preferred viscosity at a temperature of about 110° C. to about 150° C., and a slow enough rate of crystal growth to allow for manipulation of the confection product containing the saccharide mass as it was processed into a formed, shaped and finished confection portion that was hard and brittle whether it was evaluated as a stand-alone confection portion or as a portion within a multiple portion confection. For example, some of the formulas that fall within the formulas 1-3 were co-extruded with a chewing gum layer, such that the chewing gum portion was in the center of an extruded confection product rope portion. In other cases, the formulas that fall within the formulas 1-3 were part of a three portion confection made up of an extruded chewing gum ribbon portion assembled between two extruded confection portion ribbons.

Isomalt and maltitol acted similarly under the heating and cooling conditions used to make extruded confection products comprising saccharide masses, which contained isomalt or maltitol. This trend matches the similarity of maltitol's and isomalt's molecular weight, Tₘ and T_{g}. The similarity in physical properties of each of these two saccharides allowed them to be substituted for each other in formulas. Erythritol was added to a saccharide mass containing other saccharides primarily to aid in the mixing and melting of the saccharide mass. The very viscous melted isomalt or maltitol saccharide mass required significant energy during the mixing and melting process step. The addition of erythritol to the maltitol or isomalt mass before melting began in the extruder, allowed the saccharide mass to mix with less energy and at a lower viscosity because all of the erythritol crystals melted early in the mixing and heating of the saccharide mass. The very low viscosity of melted erythritol mixed with the crystalline and melted maltitol or isomalt as the saccharide mass was mixed and melted, which created a more fluid saccharide mass. The aid of the added erythritol continued as the saccharide mass was extruded and while it cooled to between 110° C. and 150° C., because the erythritol was still mostly melted (i.e., Tₘ=121° C.) and fluid (i.e., T_{g}=−42° C.), and the maltitol or isomalt was mostly crystalline (i.e., T_{g}=144° C.-147° C.) or the melted maltitol or isomalt had a high melt viscosity. This created a mass that would be fluid enough to exit the extruder after it was mixed and heated, at 110° C. and 150° C.

Molten saccharide masses that contain only simple saccharides, (including, but not limited to isomalt, maltitol, erythritol, xylitol, sorbitol) are sometimes weakly bonded between fellow simple saccharides upon exiting the die plate opening, and as such, the saccharide masses did not hold their rope, ribbon, or sheet forms for very long, if at all, after exiting the die plate opening. A complex saccharide included in the saccharide mass (before the saccharide mass is melted) created some film forming that created a more cohesive saccharide mass that did hold its extruded rope, ribbon, or sheet form. Polydextrose, polyglycitol, and corn syrup solids are examples of complex saccharides that have worked well in creating cohesive extruded masses.

TABLE 3
Saccharide Mass Formulas: Maltitol, Erythritol, Polyglycitol

| | Formula 5 | Formula 6 | Formula 7 |
|---|---|---|---|
| | (wt. %) | (wt. %) | (wt.%) |
| Maltitol | 91.59 | 86.59 | 91.59 |
| Polyglycitol | 0.27 | 8.27 | 3.27 |
| Erythritol | 1.40 | 2.8 | 2.8 |
| Color | 0.94 | 0.94 | 0.94 |
| Modified starch | 1.40 | 0 | 0 |
| Carnauba wax | 1.40 | 1.4 | 1.4 |

Table 3 contains saccharide mass formulas containing two simple saccharides (i.e., maltitol and erythritol) and one complex saccharide (i.e., polyglycitol). All of the formulas created viscosities similar to other formulas that fall within the formulas in Table 2, which had a viscosity of about 24 to about 815 Poise measured at a shearing rate of 2-8 seconds⁻¹ at a preferred temperature range of about 110° C. to about 150° C. (as measured on a Brookfield viscometer).

Sample 5 in Table 3 lists a formula containing 91.6 wt. % maltitol, 1.4 wt. % erythritol, and 3.27 wt. % polyglycitol. From Table 1 maltitol and erythritol have T_{g} values considerably lower than the 110° C.-150° C. temperature at which the saccharide mass was forced through the die plate opening, which means that these melted saccharides were way above the temperature (T_{g}) at which their amorphous physical forms transitioned between solid and fluid. On their own they could not maintain a particular extruded form for very long. If the extruded molten saccharide mass made with formula 5 was quickly applied to a second confection portion (through co-extrusion or assembling of extruded portions), the molten saccharide mass of formula 5 would still have the desired delayed rate of crystal growth, but would be difficult to use as a portion in a multiple portion confection product. The addition of polyglycitol to the saccharide mass containing simple saccharides allowed the molten saccharide mass to have the desired structure as the saccharide mass was forced through the die plate opening. At 110° C.-150° C., polyglycitol has a branched structure that could hold the smaller melted saccharides together into an extruded form more stable than one without the complex saccharide.

Table 3 also includes two other formulas (6 and 7). All three formulas in Table 3 contained maltitol, erythritol, and polyglycitol. All of these formulas created molten saccharide masses with similar viscosities at 110° C.-150° C. Granulated starch was added to the saccharide mass of formula 5, but not to formulas 6 and 7. Though the granulated starch contained long branches, the form of the starch did not make those branches accessible to the other saccharides for building cohesive structure. Water is needed to make the starch granules swell and extend their branches, and these formulas contained no water, so the starch granules (at the level used in formula 5) flowed through the molten mass as if they were inert ingredients, neither adding to nor subtracting from the effects of the other saccharides. The increase in erythritol percent did reduce the viscosity of the saccharide mass in formula 7.

Table 3 also includes a small amount of carnauba wax in all three formulas. The carnauba wax, which has a Tₘ of 82° C.-86° C., melted during the melting of the saccharide mass. The carnauba wax acted similarly to that of the erythritol, which is as a lubricant, and as such, aided in the flow of the saccharide mass during mixing and melting. As the wax was hydrophobic and the saccharides were hydrophilic, there was little interaction between the saccharide mass and the wax. The wax flowed to the exterior surface of the molten mass and aided in “sliding” the saccharide mass through the extruder and through the die plate opening. The wax also appeared to aid in reducing the stickiness of the extruded mass, probably by partially reducing the adsorption of ambient water after the mass was extruded. The wax did not appear to significantly affect the cohesiveness of the saccharide mass, or significantly affect the viscosity of the saccharide mass at 110° C.-150° C. Wax could be replaced with other materials with a melting point similar to that of wax, such as but not limited to fat. Because polyglycitol contains a significant amount of mass that does not crystallize, high levels of polyglycitol have created a molten saccharide mass with the acceptable viscosity at 110° C.-150° C., but the saccharide mass had less hardness and brittleness than a saccharide mass with no or less polyglycitol. Polyglycitol does not itself totally crystallize, and its long chain structure reduces the crystal formation of other saccharides in a saccharide mass by physically impeding crystal growth. Polydextrose acts similarly to polyglycitol as it does not crystallize and its long structure can physically impeded other saccharides from crystallizing. Polydextrose is hygroscopic and can absorb ambient moisture and create a sticky external texture. The result of using complex saccharides is that saccharide masses that contain them have a tendency towards flexible textures over a long temperature and time range. Too much of these complex saccharides in a saccharide mass can prevent enough simple saccharide crystallization that the final confection is more soft and chewy then hard and brittle.

Multiple portion confections were made using confection portions (comprising a saccharide mass) included in Table 3 and falling within the ingredient ranges in Table 2, and a chewing gum with the formula in Table 4. The chewing gum formula listed in Table 4 is an example a soft confection, and its use does not imply a limit on the possible soft confections that could be used to make a multiple portion confection, wherein one portion is a hard confection portion.

TABLE 4
Chewing Gum

| Formula | wt. % |
|---|---|
| Gum Base | 30 |
| Sorbitol Powder | 58 |
| Maltitol Syrup | 10 |
| Flavor, Coolants, Color | 1 |
| High Intensity Sweeteners | 1 |
| Total | 100 |

The chewing gum portion was made by a standard chewing gum process. The gum base was added to a mixer and then the remaining materials were added to the mixer. The mass was mixed until homogeneous. The mass was then added to a gum extruder and extruded into a ribbon, or the mass was added to a co-extruder and then extruded as a portion in a multiple portion confection. The chewing gum portion in Table 4 had a melting (i.e., softening) temperature of 50° C.-60° C., which was much lower than the melting point of most saccharides.

Multiple portion confection products were produced with confection products including saccharide masses described in Table 2 and Table 3 and the chewing gum described in Table 4. The confection masses consisted of a saccharide mass and other ingredients, such as color, flavor, wax, or combination thereof. The confection mass containing the saccharide mass was added to an extruder where the mass was mixed and melted and then forced from the extruder through a die plate opening. The extruded saccharide and gum portions were formed by co-extrusion through a nozzle with a slit opening for the gum portion surrounded by a slit opening for the confection portion, such that the co-extruded multiple portion confection had a generally ribbon form with the chewing gum portion surrounded by confection portion. The multiple portion confection was shaped into individual pieces by cutting and then finishing. The resulting samples had hard and brittle textures that were crunchy when chewed.

The samples that were an assembly of concentric layers were produced by using a co-extrusion die plate. The saccharide mass was forced through a circular slit in the die plate, as a soft confection portion (i.e., chewing gum) was forced through a hole in the center of the same die plate. Under these conditions, a multiple layer confection was formed as a two layer filled rope with the saccharide mass on the outside. Before the filled rope cooled significantly, the filled rope was shaped into individual confection pieces. The resulting samples had hard and brittle textures that were crunchy.

The multiple portion confection samples that were an assembly of laminated layers could be produced by extruding a confection portion (with a formula that would fall within the formula ranges in Table 2 or 3) through a die plate to make a first confection product ribbon, which could be placed on a conveyor belt; then extruding a chewing gum portion (with a formula similar to that in Table 4) through a different die plate to make a chewing gum portion ribbon, which could be placed on top of the first ribbon already on the conveyor; and then extruding a confection product through a die plate to make a second portion ribbon, which could be placed on top of the chewing gum ribbon. The two confection portion ribbons could flow at the edges until they touched. When the assembled three portions are cut, the portions could then pinch together or they may not. When the sides flowed together and the pieces were cut with pinching, the saccharide mass would completely enclose the chewing gum portion. When the sides did not flow together and the pieces were cut without pinching of the portions, the confection product piece would have a sandwich appearance on all sides with all portions visible. The portions could be flexible enough to flow through and out of the extruder, and flexible enough to not break when cut into individual pieces, and yet the saccharide portions could be hard, brittle, and crunchy when chewed.

The compositions and methods of the present invention are capable of being incorporated in the form of a variety of embodiments, only a few of which have been illustrated and described. The invention may be embodied in other forms without departing from its spirit or essential characteristics. The described embodiments are to be considered in all respects only as illustrative and not restrictive, and the scope of the invention, therefore, is indicated by the appended claims rather than by the foregoing description. All changes which come within the meaning and range of equivalency of the claims are to be embraced within their scope.

What is claimed is:

1. A confection product containing a saccharide mass comprising:
a. 70-98 wt. % simple saccharide; and
b. 30-1 wt. % of a different simple saccharide;
wherein the saccharide mass has a viscosity of about 24 to about 815 Poise at a shearing rate of 2-8 seconds⁻¹ when at a temperature of about 110° C. to about 150° C.

2. The confection product of claim 1, further comprising 0.30-10 wt. % complex saccharide.

3. The confection product of claim 2, further comprising 1-4 wt. % fat or wax.

4. A multiple portion confection product comprising:
a. the confection product of claim 1; and
b. an additional confection product;
wherein the confection product of claim 1 and the additional confection product are adjacent to each other, and the confection product of claim 1 has a hard and brittle texture, and the additional confection product has a soft and chewy texture.

5. A confection product containing a saccharide mass comprising:
a. 40-60 wt. % simple saccharide; and
b. 60-40 wt. % complex saccharide,
wherein the confection product has a viscosity of about 24 to about 815 Poise at a shearing rate of 2-8 seconds⁻¹ when at a temperature of about 110° C. to about 150° C.

6. The confection product of claim 5, further comprising 1-10 wt. % of a different simple saccharide.

7. The confection product of claim 5, further comprising 1-4 wt. % fat or wax.

8. A multiple portion confection product comprising:
a. the confection product of claim 5; and
b. an additional confection product,
wherein the confection product of claim 5 and the additional confection product are adjacent to each other, and the confection product of claim 5 has a hard and brittle texture, and the additional confection product has a soft and chewy texture.

9. A confection product containing a saccharide mass comprising:
c. 70-98 wt. % saccharide with a Tₘ of 92° C.-186° C.; and
d. 30-1 wt. % of a different saccharide with a Tₘ of 92° C.-186° C.;
wherein the saccharide mass has a viscosity of about 24 to about 815 Poise at a shearing rate of 2-8 seconds⁻¹ when at a temperature of about 110° C. to about 150° C.

10. The confection product of claim 9, further comprising 0.30-10 wt. % a different saccharide with a Tₘ 120° C.-180° C.

11. A multiple portion confection product comprising:
a. the confection product of claim 9; and
b. an additional confection product,
wherein the confection product of claim 9 and the additional confection product are adjacent to each other, and the confection product of claim 9 has a hard and brittle texture, and the additional confection product has a soft and chewy texture.

12. A confection product containing a saccharide mass comprising:
a. 40-60 wt. % saccharide with a Tₘ of 92° C.-186° C.; and
b. 60-40 wt. % of a different saccharide with a Tₘ 120° C.-180° C.;
wherein the saccharide mass has a viscosity of about 24 to about 815 Poise at a shearing rate of 2-8 seconds⁻¹ when at a temperature of about 110° C. to about 150° C.

13. The confection mass of claim 12, further comprising 1-10 wt. % of a different saccharide with a τₘ of 92° C.-186° C.14. The confection product of claim 12, further comprising 1-4 wt. % fat or wax.

15. A multiple portion confection product comprising:
a. the confection product of claim 12; and
b. an additional confection product,
wherein the confection product of claim 12 and the additional confection product are adjacent to each other, and the confection product of claim 12 has a hard and brittle texture, and the additional confection product has a soft and chewy texture.

16. A confection product of any of the above claims; wherein the simple saccharide is selected from the group consisting of sucrose, dextrose, glucose, fructose, maltose, isomaltulose, sorbitol, maltitol, isomalt, erythritol, xylitol, mannitol and combination thereof.

17. A confection product of any of the above claims, wherein the complex saccharide is selected from the group consisting of corn syrup solids, polydextrose, and polyglycitol.

18. A confection product of any of the above claims; wherein the confection product includes additional ingredients selected from the group consisting of flavors, colors, high intensity sweeteners, actives, sensates, and combinations thereof.

19. A confection product of any of the above claims, wherein the confection product includes additional ingredients selected from the group consisting of dry particulates, liquid ingredients and combinations thereof.

20. A confection product of claim 19, wherein the dry particulates contain ingredients selected from the group consisting of flavor beads, nut pieces, and fruit pieces.

21. A confection product of claim 19, wherein the dry particulates contain ingredients selected from the group consisting of waxes, fat, oil, sweeteners, high intensity sweeteners, colors, flavors, sensates, actives and combinations thereof.

22. A confection product of claim 19, wherein the liquid ingredients are selected from the group consisting of colored or uncolored liquids, syrups, molten sweeteners, molten waxes, molten fats, oil, high intensity sweeteners, colors, flavors, sensates, actives, chocolate, compound coating, and combinations thereof.

23. A method of making a hard confection product containing a saccharide mass comprises the steps of:
a. adding a saccharide mass into an apparatus with a screw;
b. mixing and heating the saccharide mass in the apparatus until all of the saccharide crystals are melted;
c. forcing the mixed and heated saccharide mass through an opening in the apparatus;
d. forming a rope, ribbon, or sheet of the saccharide mass as it leaves the apparatus;
e. shaping the formed saccharide mass into individual pieces; and
f. finishing the pieces by a method selected from the group consisting of pressing, embossing, dusting with particulates, spraying with liquid ingredients, pan coating, and combinations thereof.

24. A method of claim 23, wherein the opening in the apparatus is a hole in a die plate or a nozzle.

25. A method of claim 23, wherein the shaping is done with a piece of equipment selected from the group consisting of wires, knives, wheels, rollers, drop roller, rotary cutter, Uniplast and combinations thereof.

26. A method of making a multiple portion confection product containing at least one hard textured confection portion, comprises the steps of:
a. producing a hard textured confection portion of claim 1;
b. producing a soft confection portion
c. assembling the hard and soft textured confection portions so that at least one hard textured confection portion is adjacent to at least one soft textured confection portion;
d. shaping the assembled multiple portion confection into individual pieces; and
e. finishing the multiple portion confection pieces by pressing, stamping, embossing, dusting with particulates, spraying with liquids, pan coating, or combinations thereof.

27. A method of making a multiple portion confection product of claim 26, wherein the shaping is done with a piece of equipment selected from the group consisting of wires, knives, wheels, rollers, drop roller, rotary cutter, Uniplast and combinations thereof.
